(19) United States
(12) Patent Application Publication
(10) Pub. No.: US 2004/0232839 A1
(43) Pub. Date: Nov. 25, 2004

(54) Glass paste, transfer sheet, and plasma display panel

(76) Inventors: Morio Fujitani, Osaka (JP); Hiroyuki Yonehara, Osaka (JP); Masaki Aoki, Osaka (JP); Hideki Asida, Suita-shi (JP); Junichi Hibino, Neyagawa-shi (JP)

Correspondence Address: Joseph W Price, Snell & Wilmer, 1920 Main Street, Suite 1200, Irvine, CA, 92614, US

(21) Appl. No.: 10/478,891

(22) PCT Filed: May 28, 2002
(86) PCT No.: PCT/JP02/05141

(30) Foreign Application Priority Data
May 28, 2001 (JP) 2001158728

(51) Int. Cl. H01J 17/49; H01J 9/00; H01J 9/24; C03C 8/16

(52) U.S. Cl. 313/582; 313/586; 313/587; 445/24; 501/32; 501/20

(57) ABSTRACT

A glass paste used as a starting material of a transparent dielectric of a plasma display panel (“PDP”), the glass paste enabling the baking time required in forming a dielectric layer of the PDP to be shortened without reducing the transmissivity of the dielectric layer. A decomposition accelerator for accelerating the decomposition of an organic component is included in the glass paste so as to contact with the organic component. As a result, the decomposition of the organic component is accelerated when the glass paste is baked. Moreover, since the organic component is substantially eliminated before the baking temperature reaches a temperature at which a glass powder in the glass paste begins to melt, gas from decomposing organic component is not generated when the glass powder melts, and consequently the trapping of gas bubbles within the dielectric layer is prevented.

### TECHNICAL FIELD

The present invention relates to a glass paste, a transfer sheet, and a plasma display panel.

### BACKGROUND ART

Amongst color display devices used in image display for televisions and the like, plasma display panel (PDPs) in particular have attracted much attention in recent years for the potential they offer to realize high-quality image display in a large-screen display device having minimal depth.

A PDP is generally formed from front panel and a back panel that are positioned to face each other.

FIG. 7 is a partial cross-sectional view of a front panel of a PDP.

As shown in FIG. 7, the front panel includes a front glass substrate 1102, a pair of display electrodes 1103 arranged on the facing surface of substrate 1102, a transparent dielectric layer 1104 covering display electrodes 1103 and substrate 1102, and a protective layer 1105 covering dielectric layer 1104.

When driven, the PDP is illuminated by visible light that emits from phosphor layers (not shown in the drawings) on the back panel and passes through protective layer 1105, dielectric layer 1104, display electrodes 1103, and front glass substrate 1102. Thus the luminous efficiency of the PDP depends on the transmissivity of the front panel. As dielectric layer 1104 is used to insulate display electrodes 1103 it needs to be thicker than protective layer 1105, for instance, which makes layer 1104 especially susceptible to reductions in transmissivity. For this reason, it is particularly desirable to maintain a high level of the transmissivity with respect to dielectric layer 1104.

Dielectric layer 1104 is generally formed by baking at a temperature raised to 500° C. or above a dielectric layer precursor coated on front glass substrate 1102 using such methods as a paste method or a lamination method. The dielectric layer precursor is itself formed from a dried glass paste.

The following techniques are employed in the baking process to improve the transmissivity of dielectric layer 1104. A decomposition step and a melting step are provided in which an organic component (e.g. resin, solvent, surfactant) included in the glass paste is decomposed in the former step, and a glass powder included in the paste is melted in the latter step.

In the decomposition step that conducted first, the baking temperature is held for a predetermined period (approx. 10˜30 min.) at a level (approx. 350˜450° C.) that allows the organic component present in the glass powder to undergo decomposition without the glass powder itself melting. As organic components having a high molecular weight often prove particularly difficult to decompose, the provision of a holding period in the decomposition step ensures that the organic component in the glass paste is completely eliminated before the glass begins to melt.

In the melting step that follows, the baking temperature is raised to a level at which the glass powder begins to melt (e.g. the softening point of the glass powder, which is approx. 500° C.) and held at the established level for a predetermined period (approx. 10˜30 min.), whereupon the residue glass powder remaining after the holding period is vitrified through slow cooling. If the organic component is not completely eliminated in the decomposition step, gas from decomposing organic component will be generated the melting step. As shown in FIG. 7, the generated gas remains trapped in dielectric layer 1104 in the form of bubbles 1104a, and it is the existence of these bubbles in the dielectric layer that can cause a reduction in transmissivity.

In view of this problem, the holding period in the decomposition step is provided to ensure that the organic component in the glass paste is completely eliminated prior to the melting step. The generation of gas and water arising from the decomposition of organic component in the melting step can thus be suppressed, and consequently the transmissivity of layer 1104 is not compromised by the generation of bubbles 1104a.

However, the need to raise the temperature to an extremely high 500° C. or more during the baking process involves a great expenditure in energy costs. Reducing the manufacturing cost of PDPs thus becomes a matter of shortening the baking process.

One possible way of achieving this is to reduce the required time of the decomposition step. However, simply shortening the decomposition step may result in not all the organic component being eliminated within the decomposition step. Bubbles 1104a formed in dielectric layer 1104 during the melting step will then act to disperse the visible light passing through layer 1104, with the end result being the greatly reduced transmissivity of layer 1104.

The alternative is to shorten the melting step. However, the melting time of the glass powder, being proportional to the baking temperature and type of glass used, tends to be substantially fixed, which means that this alternative is not readily feasible.

Furthermore, in an extreme case, a reduction atmosphere may be formed within the melted glass as a result of there being insufficient oxygen to facilitate the consumption of resin remaining within the glass paste when the glass powder is melted during the melting step, closing off the gaps between the powder particles. Coloration of the glass and a consequent reduction in the transmissivity of the dielectric layer will result. This problem is compounded when the lamination method is used to coat the dielectric layer precursor on front glass substrate 1102, since this method employs a transfer sheet that requires more resin than does the paste method used in applying a glass paste directly onto the front glass substrate in forming the dielectric layer precursor.

In view of the issues discussed above, an object of the present invention is to provide a glass paste, a transfer sheet, a plasma display panel, and a related manufacturing method that allow for the baking process to be shortened without adversely affecting the transmissivity of the dielectric layer.

### DISCLOSURE OF THE INVENTION

The glass paste provided to achieved the object of the present invention is used as a starting material of a transparent dielectric of a plasma display panel, and is formed from a glass powder, a glass powder dispersant that includes an organic component and that disperses the glass powder, and a decomposition accelerator that accelerates the decomposition of the organic component, the decomposition accelerator in the glass paste contacting with the organic component.

The organic component in the glass powder dispersant generally includes at least one of a resin, a solvent, a surfactant, a polymerization initiator, and the like. The inclusion of the decomposition accelerator in the glass paste of the present invention allows for the rapid decomposition of the organic component when heat is applied to the glass paste in forming the dielectric layer, and the organic component can thus be completely eliminated before the glass powder begins to melt (e.g. when the baking temperature is raised to the softening point of the glass powder). As a result, the baking time required to form the dielectric layer can be reduced below conventional baking times without the transmissivity of the dielectric layer being compromised as a result of gas bubbles generated from decomposing organic component being trapped within the dielectric layer.

The decomposition accelerator may be a catalyst that accelerates a decomposition reaction of the organic component.

Specifically, the catalyst may be a member selected from the group consisting of Co, Mn, Zn, Ti, and Ni.

Alternatively, the organic component may include a resin that acts as a binder, and the decomposition accelerator may be a polymerization initiator that accelerates an initiation reaction of the resin when materials from which the resin is formed are polymerized.

Specifically, the polymerization initiator may be a radical polymerization initiator or an anionic polymerization initiator.

Alternatively, the decomposition accelerator may be a catalyst that accelerates an oxidization of the organic component.

Specifically, the catalyst may be a member selected from the group consisting of Pd, Pt, Co₃O₄, PdO, Cr₂O₃, Mn₂O₃, Ag₂O, CuO, MnO₂, CoO, and NiO.

A transfer sheet provided to achieve the object of the present invention is used in forming a transparent dielectric of a plasma display panel, and is formed from a support film and a dielectric layer precursor that is coated on the support film and that includes a glass powder, an organic component, and a decomposition accelerator for accelerating a decomposition of the organic component, the decomposition accelerator in the dielectric layer precursor contacting with the organic component. As was the case with the glass paste described above, the inclusion of the decomposition accelerator serves to accelerate the decomposition of the organic component when the glass paste is baked, and thus the transfer sheet described above is effective in shortening the baking time without compromising the transmissivity of the dielectric layer.

The present invention may also be achieved by a manufacturing method for a plasma display panel having a front glass substrate, the method being used to form a dielectric layer on the front glass substrate by baking a dielectric layer precursor coated on the front glass substrate by applying and drying a glass paste, the glass paste from which the dielectric layer precursor is formed being the glass paste described above that includes the decomposition accelerator.

According to this structure, the inclusion of the decomposition accelerator allows the decomposition of the organic component to be accelerated when the dielectric layer precursor is baked, and thus in forming the dielectric layer it becomes possible to reduce the baking time below the time conventionally required. Moreover, the rapid decomposition of the organic component allows for the organic component to be completely eliminated before the glass powder included in glass paste begins to melt, and thus bubbles are not formed within the dielectric layer.

According to this structure of the invention, there is no need to provide a holding period as required in the conventional decomposition step, and thus during the baking of the dielectric layer precursor the temperature can be continuously raised until the glass powder begins to melt, and the baking time shortened as a result.

The present invention may also be achieved by a PDP having a front glass substrate and a back glass substrate arranged to face each other with a plurality of display electrode pairs provided on a facing surface of the front glass substrate and a dielectric layer provided so as to cover the display electrodes, the dielectric layer being formed by baking the glass paste described above that includes the decomposition accelerator. This structure of the invention allows for a shortening of the baking time and a consequent reduction in manufacturing costs.

Moreover, the same effects may be achieved in a PDP whose dielectric layer is formed using a transfer sheet.

### BRIEF DESCRIPTION OF THE DRAWINGS

FIG. 1 is a exploded perspective view showing of a section of a PDP;

FIGS. 2A˜2E show side views of a front panel of a PDP during various stages of a manufacturing process according to an embodiment 1 of the present invention;

FIG. 3A is a graph showing the pattern of baking temperatures conventionally used in baking a front panel;

FIG. 3B is a graph showing the pattern of baking temperatures used in baking a front panel according to embodiment 1;

FIGS. 4A˜4C show side views of a front panel during the various baking processes according to embodiment 1.

FIGS. 5A˜5E show side views of a front panel during the various manufacturing processes according to an embodiment 2;

FIG. 6A˜6C show side views of a front panel during various stages of a baking process according to embodiment 2; and

FIG. 7 shows a cross-section of a front panel of a conventional PDP.

### BEST MODE FOR CARRYING OUT THE INVENTION

Embodiments of the present invention are described below with reference to the drawings. It should be noted that the embodiments and drawings referred to below are merely by way of example, and the present invention is by no means limited to these examples.

### Embodiment 1

(1) Structure of a PDP

The structure of a PDP will now be described.

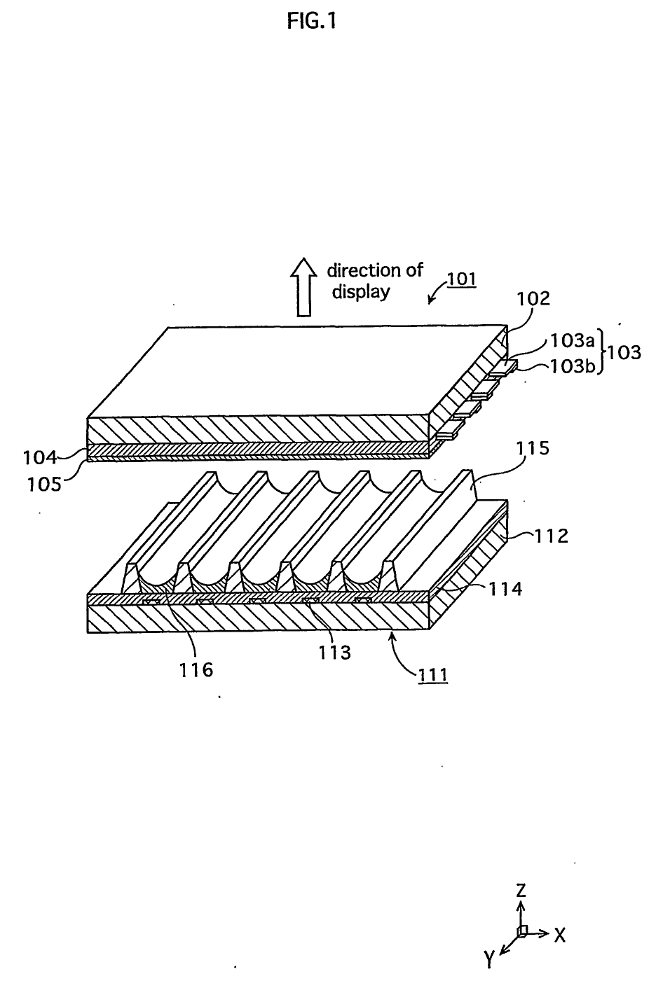

FIG. 1 is an exploded perspective view of a section of a PDP.

As shown in FIG. 1, the PDP includes a front panel 101 and a back panel 111 that are arranged to face each other. In the PDP, a protective layer 105 on front panel 101 is positioned so as to contact with the top of barrier ribs 115 arranged on back panel 111.

Front panel 101 has a front glass substrate 102 made of a sodium borosilicate glass and formed using a float method. Plural pairs of display electrodes 103 are arranged on the facing surface of substrate 102, and a dielectric layer 104 made of a transparent glass and a protective layer 105 made of magnesium oxide (MgO) are coated in the stated order on the surface of substrate 102 on which the display electrodes have been formed. Display electrodes 103 include (i) transparent electrodes 103a made of ITO and arranged in a stripe pattern on a surface of front glass substrate 102 and (ii) metal electrodes 103 b formed in a stripe pattern by laminating a material such as silver or Cu—Cr—Cu on transparent electrodes 103a. Display electrodes 103 are not limited to this structure, and may be formed, for example, without transparent electrodes 103a.

Dielectric layer 104 is formed by melting a glass powder (described in detail below) and functions to insulate the display electrodes.

Protective layer 105 is made of MgO and functions to protect the dielectric layer 104 from any sputtering that occurs when discharges are generated between the display electrodes.

Back panel 111 has a back glass substrate 112. A plurality of address electrodes 113 is arranged on the facing surface of substrate 112, and a visible light reflective layer 114 is arranged on substrate 112 to cover the address electrodes. A plurality of barrier ribs 115 is arranged on layer 114, and in the gap (i.e. rib gap) between adjacent barrier ribs 115 are arranged phosphor layers 116 that emit visible light corresponding to the colors red (R), green (G), and blue (B).

The front and back panels are arranged such that protective layer 105 on front panel 101 contacts with the top of barrier ribs 115 on back panel 111, and both panels are sealed together around their respective perimeters using a sealing material such as frit glass (not shown in the drawings). A plurality of spaces partitioned between adjacent barrier ribs 115 as a result of the sealing together of the panels is then filled with a discharge gas, being an inert gas such as He—Ne.

When the PDP is driven, the application of a pulse sequentially to each pair of display electrodes 103 on front panel 101 generates a discharge between the electrodes in each pair. The generated discharge causes the discharge gas to emit ultraviolet light, which strikes and excites phosphor layers 116 to emit visible light. The visible light then passes through protective layer 105, dielectric layer 104, transparent electrodes 103a, and front glass substrate 102. The transmission of this light allows the PDP to achieve image display.

(2) Manufacture of the Front Panel

A characteristic of the present invention lies in composition and method of baking the glass paste used in forming dielectric layer 104 of front panel 101. As such, emphasis in the following description is placed on these aspects of the manufacturing process.

Front panel 101 is formed as follows. First, display electrodes 103 are arranged on front glass substrate 102, and a glass paste is coated over the display electrodes and baked to form dielectric layer 104. Protective layer 105 is then coated over layer 104.

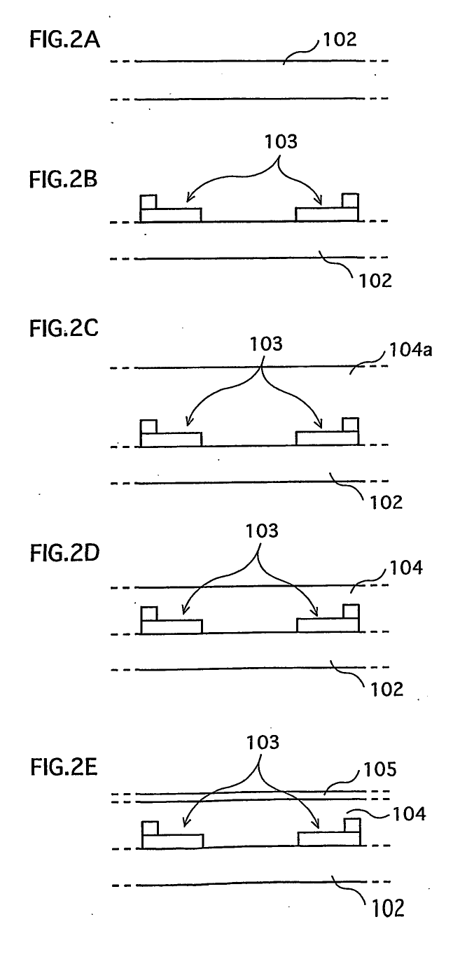

FIGS. 2A to 2E show side views of front panel 101 during various stages of the manufacturing process.

As shown in FIG. 2A, front glass substrate 102 is firstly prepared.

As shown in FIG. 2B, display electrodes 103 comprising transparent electrodes and metal electrodes are formed on a principle surface of front glass substrate 102 using thin or thick film methods (e.g. a screen-printing method employing a screen patterned in the shape of the electrodes, or a method of patterning the electrodes using a photographic method after first applying an electrode paste using a die coating method, or a lamination method involving the transfer of a prefabricated electrode film onto the front glass substrate).

As shown in FIG. 2C, a glass paste is applied using such methods as a screen-printing method or a die coating method to the surface of front glass substrate 102 on which display electrodes 103 have been formed, and the applied paste is dried to form a dielectric layer precursor 104a.

The glass paste used in forming dielectric layer precursor 104a is itself formed from a compound that includes a glass powder made of transparent glass, a solvent, a resin that acts as a binder and that helps to disperse the glass powder evenly throughout the solvent, and a decomposition accelerator that reduces the molecular weight of organic components (e.g. resin, solvent) included in the glass paste by accelerating the decomposition or oxidization (i.e. combustion) of the organic components. Here, “organic component” is used to refer to all organic materials included in the glass paste. Apart from resins and solvents, organic materials such as surfactants and polymerization initiators may also be included in the glass paste.

Dissolving resin in the solvent produces a solution having a certain viscosity, and the viscous solution acts as a dispersant for dispersing the glass powder evenly throughout the solvent (hereafter, a compound that includes solvent and resin will be referred to as a “glass powder dispersant”). Surfactants, polymerization initiators, and the like may also be included in the glass powder dispersant. Moreover, if the resin is itself a viscous liquid, the glass powder dispersant need not include a solvent.

Here, the material used as a solvent should preferably have good evaporation properties and also be highly compatible with the glass powder. Furthermore, the material should be able to readily dissolve the organic component, and also be able to provide the glass paste with the desired viscosity at the time the glass paste is applied. Specifically, materials such as acetate-n-butyl, butyl carbitol acetate (BCA), and terpineol may be used as the solvent, and the solvent may be one or a compound of these materials. In order for the solvent to maintain the viscosity of the glass paste at the desired level, the solvent should be present in the glass paste at 40 wt % or less of the glass powder, with the preferred range being 5 wt % to 30 wt %.

Although there are no specific restrictions concerning the material used as the glass powder, preferably the material should have a softening point in a range of 400° C. to 600° C. The material may, for example, be any of the following glass frit powders (e.g. having a average particle size of 5˜15 μm): a compound consisting of lead oxide, boric oxide, and silicon oxide (PbO—B₂O₃—SiO₂), a compound consisting of zinc oxide, boric oxide, and silicon oxide (ZnO—B₂O₃SiO₂), a compound consisting of lead oxide, boric oxide, silicon oxide, and aluminum oxide (PbO—B₂O₃—SiO₂—Al₂O₃), or a compound consisting of lead oxide, zinc oxide, boric oxide, and silicon oxide (PbO—ZnO—B₂O₃—SiO₂).

Materials such as ethyl cellulose or acrylic resins may be used as the resin. A weight-average molecular weight of the resin measured by gel permeation chromatography (GPC) calibrated using polystyrene standards should preferably be in a range of 4,000 to 300,000. The resin should be present in the glass paste in a range of 5 wt % to 40 wt % of the glass powder, with the preferred range being 10 wt % to 30 wt %. The reason for setting this range is that at resin amounts below 5 wt % the viscosity of the glass paste cannot be maintained within the desired range at the time of application, whereas at resin amounts above 40 wt % an excess amount of time is required to completely eliminate the resin in the baking process (described below in detail), which compromises the strength and thickness of the dielectric layer.

A catalyst, a polymerization initiator, or a peroxide may be used as the decomposition accelerator. While it is well known that the application of heat, light, or radiation to an organic component formed from macromolecules such as a resin will result in a reduction in the molecular weight of the organic component through decomposition, the inclusion of a decomposition accelerator in the glass paste helps to accelerate this decomposition process.

It is also well known that the decomposition of the main chain of a macromolecule causes both a polymerization reaction and a depolymerization reaction. The polymerization and depolymerization reactions proceed at the same time, with the speed of the reactions reaching equilibrium at the so-called ceiling temperature of the organic component. Generally, at temperatures below the ceiling temperature the polymerization reaction proceeds at greater speed. The addition of a catalyst serves to reduce the activation energy of the polymerization reaction and thus further increase the reaction speed. In contrast, at temperatures above the ceiling temperature the depolymerization reaction proceeds at greater speed, and the decomposition of organic component present in a glass paste that includes a catalyst becomes abrupt at such temperatures. Materials such as Co, Mn, Zn, Ti, and Ni may be used as the catalyst component. Co, Mn, Zn, and Ni are commonly used when the organic component is synthesized by a polycondensation reaction, and Co, Ti, and Ni are commonly used when the organic component is synthesized by an addition polymerization reaction.

When an acrylic resin such as polymethyl methacrylate is used as the organic component (i.e. synthesis by addition polymerization reaction), for example, the use of a decomposition accelerator selected from the group consisting of Co, Ti, and Ni, and the application of a temperature in excess of the ceiling temperature (220° C. in the case of polymethyl methacrylate) of the resin, will cause the polymethyl methacrylate to decompose at a rate faster than conventional rates, and the polymethyl methacrylate readily decomposes to a monomer state.

Apart from a catalyst, a polymerization initiator may alternatively be used as the decomposition accelerator.

When an acrylic resin is synthesized by a radical polymerization reaction or an anionic polymerization reaction, for example, a polymerization initiator may be added at the commencement of the polymerization process. For the same reasons as given above in regard to the catalyst, the inclusion of a polymerization initiator in the glass paste serves to rapidly accelerate the depolymerization reaction at temperatures above the ceiling temperature of the resin, as well as accelerating the decomposition of the resin and thereby reducing its molecular weight.

Here, a peroxide or an azo compound may be used as the radial polymerization reaction initiator. Specifically, the initiator in this case may be a member selected from the group consisting of, for example, benzoylperoxide, azobisisobutyronitrile, cumenehydroperoxide, tertiary butylhydroperoxide, and persulfate. On the other hand, a lithium alkyl catalyst such as n-butyl lithium, for example, may be used as the anionic polymerization reaction initiator.

The decomposition accelerators described above serve to accelerate the decomposition of the organic component included in the glass paste. However, it is alternatively possible to use a decomposition accelerator that reduces the molecular weight of the organic component by accelerating its oxidization (i.e. combustion). The combustion of most organic components is generally accelerated by employing a catalyst. A catalyst is well suited for use as a decomposition accelerator because in addition to the fact that only small amounts are needed to accelerate the oxidization of an organic component, the catalyst itself remains chemically stable and is not changed by combustion. Furthermore, such a catalyst is also effective in accelerating the oxidization of solvents and other non-macromolecular organic components.

The catalyst employed as a decomposition accelerator for accelerating the combustion of the organic component may be selected depending on a molecular structure of the chemical compound used in the organic component by referring to the hierarchy of combustion reactions (i.e. the hierarchy of relative strengths of the catalysts) given below. For example, the combustion reaction hierarchy for methane is Pd>Pt>Co₃O₄>PdO>Cr₂O₃>Mn₂O₃. In contrast, the combustion reaction hierarchy for polypropylene is Pt>Pd>Ag₂O>Co₃O₄ >CuO>MnO₂. And the combustion reaction hierarchy for carbon monoxide is CoO>NiO>MnO₂. Moreover, the addition to the glass paste of an organic component having a functional group that includes a peroxide and oxygen serves, in addition to accelerating the decomposition process, to supplement the amounts of oxygen needed for combustion.

The above decomposition accelerators may be included in the glass paste to be present in a range of 0.1 wt % to 10 wt % of the glass powder. The preferred range is 0.5 wt % to 5 wt %, while a range of 1 wt % to 3 wt % is even more preferable. This range is set because at amounts below 0.1 wt % there may be insufficient reductions in the molecular weight of the organic component, whereas at amounts above 10 wt % the color of the decomposition accelerator may stain the front panel.

The glass paste may be formed by mixing together the glass powder, solvent, resin, decomposition accelerator, and the like described above using a mixer, a roll mixer, a homomixer, or other such mixing devices. Alternatively, the glass powder and decomposition accelerator may be dispersed using a solvent, and then baked and dried so that the decomposition accelerator adheres to the particle surfaces of the glass powder. Resin and solvent can then be added to form a paste. To facilitate the application of the glass paste, the viscosity of the paste should be in a range of 1 pa·s to 30 Pa·s, with the preferred range being 3 Pa·s to 10 Pa·s.

Dielectric layer precursor 104a shown in FIG. 2C is formed by applying the glass paste to front glass substrate 102 using a roll coater, a blade coater, or the like.

Next, front glass substrate 102 having dielectric layer precursor 104a formed thereon is baked to form dielectric layer 104 as shown in FIG. 2D.

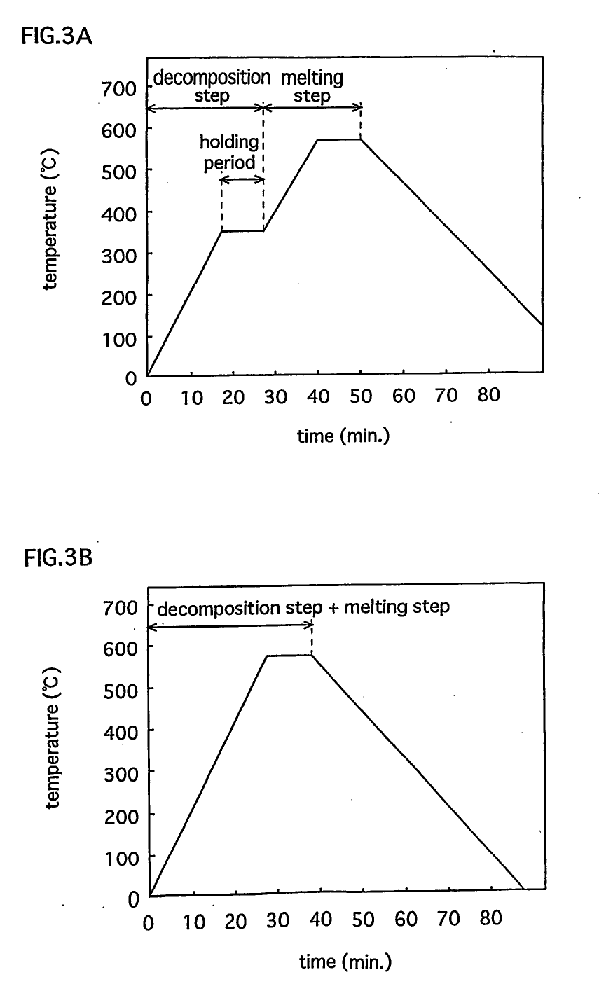

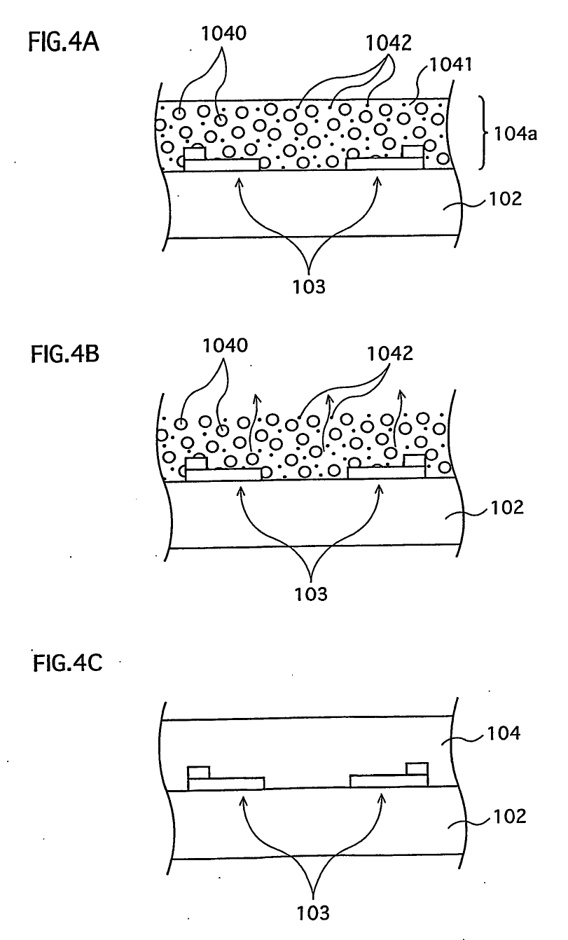

FIG. 3A is a graph plotting a conventional baking temperature and baking time. FIG. 3B is a graph plotting a baking temperature and baking time according to embodiment 1. FIGS. 4A to 4C show side views of the front panel during various stages of the baking process according to embodiment 1.

First, a conventional process of baking a front panel will be described, before moving on to describe the baking process according to embodiment 1.

As shown in FIG. 3A, in the decomposition step of the conventional baking process, the baking temperature is raised to a temperature in the neighborhood of 350° C. so as to allow for the organic component in the glass paste to decompose without also causing the glass powder to melt, and the temperature is then held at that level for approximately 10 to 30 minutes. This process allows for the sufficient decomposition of the organic component, and the decomposed organic component disperses out through the gaps between the glass powder particles. If the holding period is either not provided or not sufficiently long, the organic component will remain incompletely decomposed at the end of the decomposition step. The organic component remaining will then decompose within the melting glass powder in the melting step that follows, and the gas generated as a result of the decomposing organic component may remain trapped within the dielectric layer in the form of bubbles. Shortening the holding period of the decomposition step is thus not readily feasible when conventional glass pastes are employed.

According to embodiment 1 in contrast, a decomposition accelerator is included in dielectric layer precursor 104a coated on front panel 101. As shown in FIG. 4A, included in dielectric layer precursor 104a is a glass powder 1040, a glass powder dispersant 1041 that includes an organic component and that disperses the glass powder, and a decomposition accelerator 1042 that serves to reduce the molecular weight of the organic component included in glass powder dispersant 1041. Moreover, decomposition accelerator 1042 is present, not within glass powder 1040, but so as to contact with the organic component in dispersant 1041. For this reason, the decomposition rate of the organic component is markedly increased at baking temperatures above the ceiling temperature of the organic component, which makes it possible to achieve a sufficient decomposition of the organic component even before a temperature of 350° C. is reached. As shown in FIG. 3B, it thus becomes possible to either shorten or eliminate the holding period required in the conventional decomposition step, and the overall time required to complete the baking process can be reduced as a result.

As shown in FIG. 4B, the gas generated by the decomposition of organic component disperses out through the gaps between the particles of glass powder 1040, such that only the glass powder remains in dielectric layer precursor 104a at the completion of the decomposition step.

In the melting step that follows, the baking temperature is raised to the softening point or above of the glass powder, and the residue glass powder is melted by holding the temperature at the established level for a predetermined period, such that the gaps between the powder particles are eliminated (note: when the decomposition step holding period is not required, the temperature may be continuously raised as shown in FIG. 3B from room temperature to the softening point). Dielectric layer 104 is completed by reducing the temperature of the front panel to room temperature, the end result being, as shown in FIG. 4C, a dielectric layer without bubbles and having excellent transmissivity.

Finally, as shown in FIG. 2E, aprotective layer 105 made of MgO is coated on dielectric layer 104 to complete front panel 101 (FIG. 1).

In summary, the use of a glass paste that includes a decomposition accelerator in forming of a dielectric layer of a PDP, allows for the required baking time to be shortened without adversely generating bubbles within the dielectric layer (i.e. without impairing the transmissivity of the dielectric layer). In other words, the baking time can be shortened without compromising the brightness of the PDP.

(3) Manufacture of Back Panel 111

An exemplary manufacturing method for back panel 111 is described below with reference to FIG. 1.

First, address electrodes 113 are formed in a stripe pattern on back substrate 112 by screen-printing a silver electrode paste on substrate 112 and baking the screen-printed paste. Next, the screen-printing method is used to apply over address electrodes 113 a glass paste formed by adding titanium oxide to the same glass paste used in forming dielectric layer 104. Visible light reflective layer 114 is formed by baking the applied glass paste according to the same baking process used in manufacturing the front panel.

Next, a screen-printing method is used to repeatedly apply on visible light reflective layer 114 at a predetermined pitch a paste that includes a lead glass material, and the applied paste is baked to form barrier ribs 115. The formation of barrier ribs 115 creates discharge spaces that are partitioned per cell (i.e. per lumination area) in the x direction. Here, the baking of both address electrodes 113 and visible light reflective layer 114 may be conducted together with the baking of barrier ribs 115.

Next, a phosphor ink that is in paste form and that includes phosphor particles corresponding to one the colors red (R), green (G), and blue (B) is repeatedly applied in the stated order in the rib gap between adjacent barrier ribs 115 such that one color is applied per gap. Phosphor layers 116 are formed by baking the applied phosphor ink at a temperature of 400° C. to 590° C., which serves to burn off the resin in the ink and also to melt the phosphor particles so that they fuse together.

(4) Sealing Together of the Panels

Front panel 101 and back panel 111 manufactured as described above are placed together such that display electrodes 103 extend in an orthogonal direction to address electrodes 113, and a sealant glass is inserted around a perimeter area of the panels. The inserted sealant glass is then baked, for example, at a temperature of approximately 450° C. for 10 to 20 minutes to form an airtight sealing layer (not shown in the drawings) which serves to seal together the front and back panels. A high vacuum (e.g. 1.1×10⁻⁴Pa) is then created within the discharge space between adjacent barrier ribs, and the discharge spaces are filled at a predetermined pressure with a discharge gas (e.g. an inert gas such as He—Xe, Ne—Xe) to complete the manufacture of the PDP.

Manufacturing a PDP according to embodiment 1 of the present invention allows for a reduction in manufacturing costs as a result of being able to shorten the baking time required in forming the dielectric layer of the front panel.

(5) Testing

Embodiment samples 1 to 18 were manufactured in which a dielectric layer was formed on a glass substrate using a glass paste, each of the glass pastes including one of the decomposition accelerators described above in relation to embodiment 1. The transmissivity of each of the manufactured embodiment samples was then measured.

Comparative samples 1 and 2 were also manufactured in which a dielectric layer was formed on a glass substrate using a glass paste that did not include a decomposition accelerator, and the transmissivity of the comparative samples was also measured. Furthermore, the baking of the dielectric layer of the embodiment samples and comparative sample 1 was conducted according to the embodiment 1 pattern shown in FIG. 3B. Comparative sample 2, however, was baked according to the conventional pattern shown in FIG. 3A, with a holding period of 30 minutes being provided in the decomposition step.

The types of decomposition accelerator included in the glass pastes used in the embodiment/comparative samples as well as the added amounts are shown in Table 1.

TABLE 1

| | | | | All-Diffused |
|---|---|---|---|---|
| | | | Baking | Transmissivity |
| | Decomposition | Amount | Pattern | of Dielectric |
| Sample | Accelerator | (wt %) | (*) | Layer (%) |
| Embod. Samp. 1 | Co | 1 | 1 | 86 |
| Embod. Samp. 2 | Mn | 1 | 1 | 85 |
| Embod. Samp. 3 | Ti | 1 | 1 | 87 |
| Embod. Samp. 4 | Ni | 1 | 1 | 82 |
| Embod. Samp. 5 | Benzoylperoxide | 2 | 1 | 83 |
| Embod. Samp. 6 | Azobisiso | 2 | 1 | 83 |
| | butyronitrile | | | |
| Embod. Samp. 7 | n-Butyllithium | 2 | 1 | 85 |
| Embod. Samp. 8 | Pd | 0.5 | 1 | 88 |
| Embod. Samp. 9 | Pt | 0.5 | 1 | 88 |
| Embod. Samp. 10 | Co₃O₄ | 1 | 1 | 85 |
| Embod. Samp. 11 | PdO | 0.5 | 1 | 84 |
| Embod. Samp. 12 | Cr₂O₃ | 1 | 1 | 84 |
| Embod. Samp. 13 | Mn₂O₃ | 1 | 1 | 85 |
| Embod. Samp. 14 | Ag₂O | 1 | 1 | 83 |
| Embod. Samp. 15 | CuO | 1 | 1 | 88 |
| Embod. Samp. 16 | MnO₂ | 1 | 1 | 87 |
| Embod. Samp. 17 | CoO | 1 | 1 | 84 |
| Embod. Samp. 18 | NiO | 1 | 1 | 83 |
| Compar. Samp. 1 | — | — | 1 | 78 |
| Compar. Samp. 2 | — | — | 2 | 83 |

(*) “1” = baking pattern shown in FIG. 3B
“2” = baking pattern shown in FIG. 3A

### Embodiment Samples 1 to 18

The glass substrate of both the embodiment and comparative samples was made from PD200 (Asahi Glass Company) using the float method. The components used as the decomposition accelerator are as shown in Table 1, and the amounts included in the glass paste are given as a percentage of the glass powder. Ethyl cellulose was used as the resin, and the dielectric layers were formed to have a thickness of 30 μm after baking.

### Comparative Sample 1

The composition of the dielectric layer (30 μm in thickness) and the baking process used was the same as that of the embodiment samples, the only difference being the non-inclusion of a decomposition accelerator in the glass paste.

### Comparative Sample 2

The composition of the glass paste was the same as that of comparative sample 1. However, the decomposition step was conducted according to the baking pattern shown in FIG. 3A, with a 30-minute holding period being provided.

### Measuring the Transmissivity

The all-diffused transmissivity of the glass substrates on which the dielectric layers were formed was measured using a spectrophotometer CM-3500d (Minolta). The transmissivity of each glass substrate was measured prior to the dielectric layer being formed, and the measured transmissivity of the glass substrate was then subtracted from the overall transmissivity result in order to obtain a measurement for the transmissivity of the dielectric layer of each sample. The results are given in Table 1.

As shown in Table 1, the all-diffused transmissivity for embodiment samples 1 to 18 and comparative sample 2 were measured at 83% or above. The result shows that the embodiment samples manufactured according to the present invention were able to achieve a level of transmissivity equal to or above the transmissivity of the dielectric layer of comparative sample 2 formed according to the conventional baking pattern. In comparison, the transmissivity of comparative sample 1 was measured at 78%, which is at least 5% lower than that of the embodiment samples.

The reason for the comparatively low transmissivity of comparative sample 1, on the other hand, is thought to be the non-inclusion of a decomposition accelerator in the glass paste. In other words, the insufficient decomposition of the organic component caused bubbles to form in the dielectric layer as a result of gas generated from the decomposition of organic component when the glass particles were melted.

Furthermore, VGA compatible 42-inch PDPs were manufactured that had dielectric layers formed according to embodiment samples 1 to 18 and comparative samples 1 and 2, barrier ribs 115 of 0.15 mm in height, rib gaps (i.e. cell pitch) between adjacent barrier ribs 115 of 0.36 mm in width, and electrode gaps between adjacent display electrodes 103 of 0.1 mm in width, and the brightness of each of the PDPs was measured under identical drive condition. A comparison of the results showed that the brightness levels of the PDPs having dielectric layers formed in accordance with embodiment samples 1 to 18 and comparative sample 2 were approximately 5% higher than the brightness level of the PDP having the dielectric layer of comparative sample 1. Thus, usage of the glass paste of the present invention makes it possible to secure brightness levels equivalent to or higher than those of conventional PDPs, while at the same time reducing the baking time and consequently the costs involved in manufacturing a PDP. Moreover, no discoloring of the front panel was evident at the decomposition accelerator amounts given in Table 1.

Ethyl cellulose was used as the organic component in the samples, although the same effects can be achieved using acrylic resins. Also, the material used as the decomposition accelerator need not itself be a material that accelerates the decomposition of the organic component. The decomposition accelerator may, for example, be a chemical compound that changes, when heat is applied during the baking process, into a material for accelerating the decomposition of the organic component.

### Embodiment 2

In embodiment 1, the glass paste is applied directly onto the front glass substrate in forming the dielectric layer of the front panel. In embodiment 2, in comparison, a transfer sheet is employed that includes a support film and a dielectric layer precursor. The transfer sheet is manufactured by applying a glass paste to the support film (i.e. rather than the front glass substrate) and drying the applied paste to form the dielectric layer precursor on the support film. Since the only substantial difference between the structure of the PDP according to embodiments 1 and 2 relates to the forming of the dielectric layer, the description below focuses mainly on this facet.

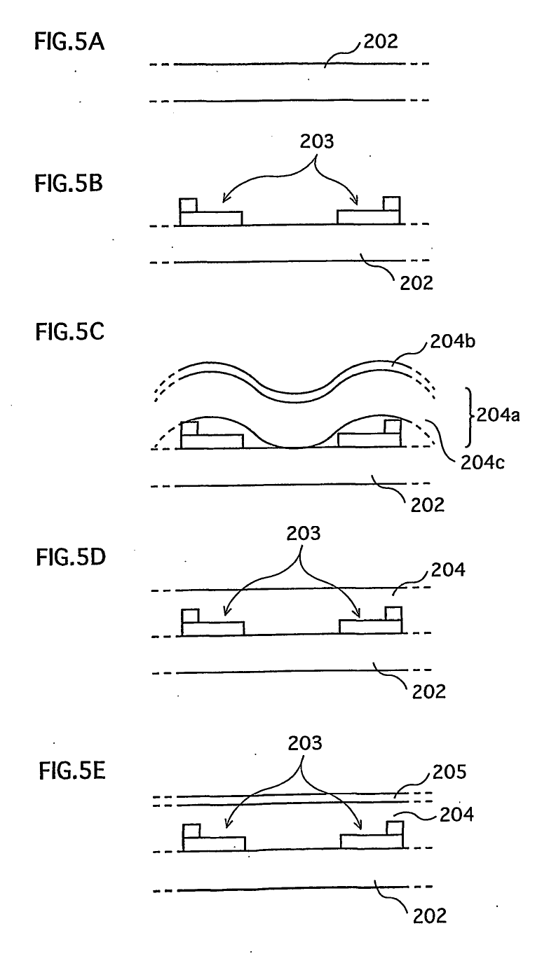

FIGS. 5A to 5E show side views of a front panel during various stages of the manufacturing process.

As with embodiment 1 (see FIG. 2), a front glass substrate 202 as shown in FIG. 5A is prepared, and then as shown in FIG. 5B, display electrodes 203 are formed in a stripe pattern on substrate 202 using a thick or a thin film method.

Next, as shown in FIG. 5C, a transfer sheet 204a is press-adhered to the surface of front glass substrate 202 on which display electrodes 203 have been arranged, covering the display electrodes.

Transfer sheet 204a includes a support film 204b, a cover film (not shown in the drawings), and a dielectric layer precursor 204c formed from a dried glass paste and sandwiched between the support and cover films, the cover film being removed prior to sheet 204a being press-adhered to substrate 202. This structure of the transfer sheet helps to protect the dielectric layer precursor from contamination by dust and other matter.

Support film 204b preferably should be formed from a resin that has excellent flexibility properties as well as being both heat resistant and solvent resistant (i.e. with respect to solvent included in the glass paste). Specifically, the support film (20˜100 μm in thickness) may be formed from a member of the group consisting of polyethylene, polypropylene, polystyrene, polyimide, polyvinyl alcohol, and polyvinyl chloride.

Next, a glass paste having the same composition as the glass paste of embodiment 1 is applied to support film 204b in an even thickness using a roll coater, a blade coater (e.g. a doctor blade), a curtain coater, a wire coater, a fountain coater, or the like. Dielectric layer precursor 204c is then formed by drying the applied glass paste, for example, for a period of approximately 0.1 to 30 minutes while maintaining the temperature in a range of 40° C. to 150° C. The amount of solvent remaining in precursor 204c is generally at or below 10 wt %, with the preferred amount being 1 wt % to 5 wt %, which allows precursor 204c to retain the viscosity and shape-holding properties necessary for adhering to front glass substrate 202.

Transfer sheet 204 is completed by crimping over dielectric layer precursor 204c a cover film of the same composition and thickness as support film 204b. The flexibility of the support and cover films allows transfer sheet 204a to be rolled up and stored compactly.

After first removing the cover film, transfer sheet 204a is press-adhered to front glass substrate 202 under application of heat. After sheet 204a has been press-adhered to substrate 202, support film 204b is removed to leave dielectric layer precursor 204c coated on the surface of substrate 202 on which display electrodes 203 have been arranged. A removal process preferably should be conducted to facilitate the easy removal of the cover and support films.

Dielectric layer 204 as shown in FIG. 5D is completed by baking front glass plate 202 coated with dielectric layer precursor 204c according to the same baking pattern as described in embodiment 1 (see FIG. 3B).

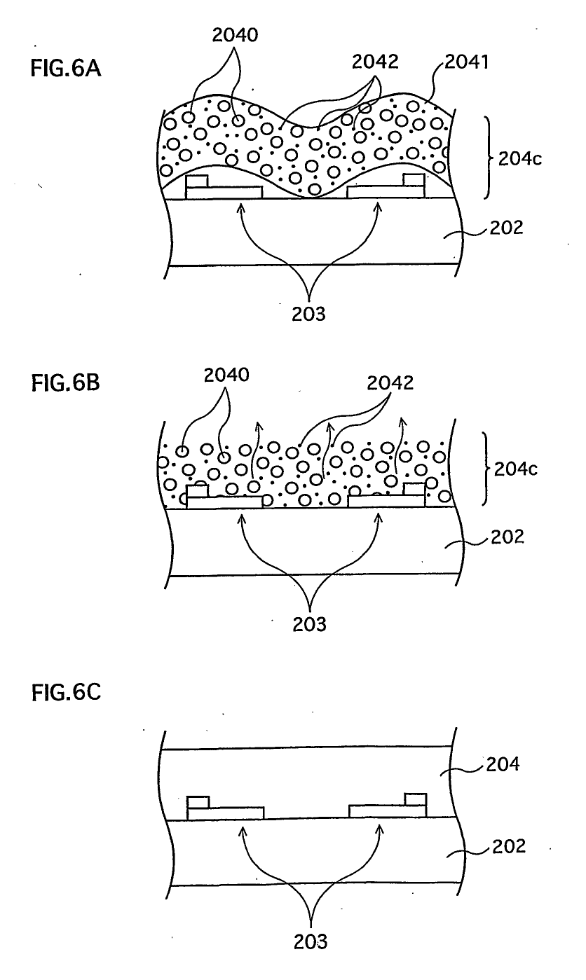

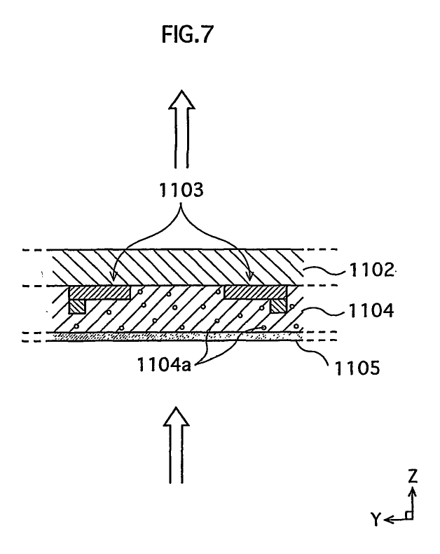

FIGS. 6A to 6C show side views of the front panel during the various stages of baking dielectric layer precursor 204c.

As shown in FIG. 6A, precursor 204c is formed from the same materials as used in the glass paste of embodiment 1. That is, a glass powder 2040, a glass powder dispersant 2041 that includes an organic component (e.g. resin, solvent) and that disperses the glass powder, and a decomposition accelerator 2042 for reducing the atomic weight of the organic component through decomposition.

By baking the front panel according to the pattern shown in FIG. 3B, the reduction in the molecular weight of the organic component in precursor 204c is accelerated due to the fact that it contacts with the decomposition accelerator, and as a result the organic component completely decomposes during an initial period in which the temperature rises from the ceiling temperature of the organic component to approximately 350° C. The gas generated from decomposing organic component volatilizes and disperses out through the gaps between the particles of glass powder 2040. In other words, the substantial elimination of the organic component in precursor 204c can be achieved before the baking temperature rises to the softening point of glass powder 2040 without needing to provide a holding period as in the conventional decomposition step.

Once the temperature is such that the glass powder begins to melt, the temperature is held at the established level so as to facilitate the melting of the glass powder, which eliminates the gaps between the powder particles. Dielectric layer 204, as shown in FIG. 6C, is formed as a result. Layer 204 is then hardened on front glass substrate 204 by slow cooling the front panel. Because the organic component in dielectric layer precursor 204c is eliminated before the temperature reaches 350° C. (i.e. well before the softening point of the glass powder), dielectric layer 204 is formed without bubbles.

Finally, as shown in FIG. 5E, a protective layer 205 is coated over dielectric layer 204 to complete the front panel.

As demonstrated above, the use of the transfer sheet of embodiment 2 in forming dielectric layer 204 allows for the same effects as in embodiment 1 to be achieved; that is, for the baking time to be shortened without bubbles being generated in dielectric layer 204.

### Industrial Applicability

The glass paste, transfer sheet, and plasma display panel of the present invention are applicable in the manufacture of reduced-cost PDPs.

1. A glass paste used as a starting material of a transparent dielectric of a plasma display panel, comprising:
a glass powder;
a glass powder dispersant that includes an organic component and that disperses the glass powder; and
a decomposition accelerator for accelerating a decomposition of the organic component, wherein
the decomposition accelerator contacts with the organic component.

2. The glass paste according to claim 1, wherein
the decomposition accelerator is a catalyst that accelerates a decomposition reaction of the organic component.

3. The glass paste according to claim 2, wherein
the catalyst is at least one member selected from the group consisting of Co, Mn, Zn, Ti, and Ni.

4. The glass paste according to claim 1, wherein
the organic component includes a resin that acts as a binder, and
the decomposition accelerator is a polymerization initiator that accelerates an initiation reaction of the resin when a material from which the resin is formed is polymerized.

5. The glass paste according to claim 4, wherein
the polymerization initiator is a radical polymerization initiator.

6. The glass paste according to claim 5, wherein
the radical polymerization initiator is a peroxide or an azo compound.

7. The glass paste according to claim 6, wherein
the peroxide or the azo compound is at least one member selected from the group consisting of benzoylperoxide, azobisisobutyronitrile, cumenehydroperoxide, tertiary butylhydroperoxide, and persulfate.

8. The glass paste according to claim 4, wherein
the polymerization initiator is an anionic polymerization initiator.

9. The glass paste according to claim 8, wherein
the anionic polymerization initiator is an alkyllithium catalyst.

10. The glass paste according to claim 1, wherein
the decomposition accelerator is a catalyst that accelerates an oxidization of the organic component.

11. The glass paste according to claim 10, wherein
the catalyst is at least one member selected from the group consisting of Pd, Pt, Co₃O₄, PdO, Cr₂O₃, Mn₂O₃, Ag₂O, CuO, MnO₂, CoO, and NiO.

12. A transfer sheet used in forming a transparent dielectric of a plasma display panel, the transfer sheet having a support film and a dielectric layer precursor coated on the support film, the dielectric layer precursor comprising:
a glass powder;
an organic component; and
a decomposition accelerator for accelerating a decomposition of the organic component, wherein
the decomposition accelerator contacts with the organic component.

13. The transfer sheet according to claim 12, wherein
the decomposition accelerator is a catalyst that accelerates a decomposition reaction of the organic component.

14. The transfer sheet according to claim 13, wherein
the catalyst is at least one member selected from the group consisting of Co, Mn, Zn, Ti, and Ni.

15. The transfer sheet according to claim 12, wherein
the organic component includes a resin that acts as a binder, and
the decomposition accelerator is a polymerization initiator that accelerates an initiation reaction of the resin when a material from which the resin is formed is polymerized.

16. The transfer sheet according to claim 15, wherein
the polymerization initiator is a radical polymerization initiator.

17. The transfer sheet according to claim 16, wherein
the radical polymerization initiator is a peroxide or an azo compound.

18. The transfer sheet according to claim 17, wherein
the peroxide or the azo compound is at least one member selected from the group consisting of benzoylperoxide, azobisisobutyronitrile, cumenehydroperoxide, tertiary butylhydroperoxide, and persulfate.

19. The transfer sheet according to claim 15, wherein
the polymerization initiator is an anionic polymerization initiator.

20. The transfer sheet according to claim 19, wherein
the anionic polymerization initiator is an alkyllithium catalyst.

21. The transfer sheet according to claim 12, wherein
the decomposition accelerator is a catalyst that accelerates an oxidization of the organic component.

22. The transfer sheet according to claim 21, wherein
the catalyst is at least one member selected from the group consisting of Pd, Pt, Co₃O₄, PdO, Cr₂O₃, Mn₂O₃, Ag₂O, CuO, MnO₂, CoO, and NiO.

23. A manufacturing method for a plasma display panel having a front glass substrate, the method being used in forming a dielectric layer on the front glass substrate by baking a dielectric layer precursor coated on the front glass substrate by applying and drying a glass paste, wherein
the glass paste from which the dielectric layer precursor is formed is a glass paste as in claim 1.

24. The method according to claim 23, wherein
a baking temperature of the dielectric layer precursor is raised until a softening point of a glass powder included in the glass paste is reached.

25. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a glass paste as in claim 1.

26. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a dielectric layer precursor transferred from a transfer sheet as in claim 12.

27. A manufacturing method for a plasma display panel having a front glass substrate, the method being used in forming a dielectric layer on the front glass substrate by baking a dielectric layer precursor coated on the front glass substrate by applying and drying a glass paste, wherein
the glass paste from which the dielectric layer precursor is formed is a glass paste as in claim 2.

28. A manufacturing method for a plasma display panel having a front glass substrate, the method being used in forming a dielectric layer on the front glass substrate by baking a dielectric layer precursor coated on the front glass substrate by applying and drying a glass paste, wherein
the glass paste from which the dielectric layer precursor is formed is a glass paste as in claim 3.

29. A manufacturing method for a plasma display panel having a front glass substrate, the method being used in forming a dielectric layer on the front glass substrate by baking a dielectric layer precursor coated on the front glass substrate by applying and drying a glass paste, wherein
the glass paste from which the dielectric layer precursor is formed is a glass paste as in claim 4.

30. A manufacturing method for a plasma display panel having a front glass substrate, the method being used in forming a dielectric layer on the front glass substrate by baking a dielectric layer precursor coated on the front glass substrate by applying and drying a glass paste, wherein
the glass paste from which the dielectric layer precursor is formed is a glass paste as in claim 5.

31. A manufacturing method for a plasma display panel having a front glass substrate, the method being used in forming a dielectric layer on the front glass substrate by baking a dielectric layer precursor coated on the front glass substrate by applying and drying a glass paste, wherein
the glass paste from which the dielectric layer precursor is formed is a glass paste as in claim 6.

32. A manufacturing method for a plasma display panel having a front glass substrate, the method being used in forming a dielectric layer on the front glass substrate by baking a dielectric layer precursor coated on the front glass substrate by applying and drying a glass paste, wherein
the glass paste from which the dielectric layer precursor is formed is a glass paste as in claim 7.

33. A manufacturing method for a plasma display panel having a front glass substrate, the method being used in forming a dielectric layer on the front glass substrate by baking a dielectric layer precursor coated on the front glass substrate by applying and drying a glass paste, wherein
the glass paste from which the dielectric layer precursor is formed is a glass paste as in claim 8.

34. A manufacturing method for a plasma display panel having a front glass substrate, the method being used in forming a dielectric layer on the front glass substrate by baking a dielectric layer precursor coated on the front glass substrate by applying and drying a glass paste, wherein
the glass paste from which the dielectric layer precursor is formed is a glass paste as in claim 9.

35. A manufacturing method for a plasma display panel having a front glass substrate, the method being used in forming a dielectric layer on the front glass substrate by baking a dielectric layer precursor coated on the front glass substrate by applying and drying a glass paste, wherein
the glass paste from which the dielectric layer precursor is formed is a glass paste as in claim 10.

36. A manufacturing method for a plasma display panel having a front glass substrate, the method being used in forming a dielectric layer on the front glass substrate by baking a dielectric layer precursor coated on the front glass substrate by applying and drying a glass paste, wherein
the glass paste from which the dielectric layer precursor is formed is a glass paste as in claim 11.

37. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a glass paste as in claim 2.

38. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a glass paste as in claim 3.

39. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a glass paste as in claim 4.

40. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a glass paste as in claim 5.

41. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a glass paste as in claim 6.

42. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a glass paste as in claim 7.

42. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a glass paste as in claim 8.

43. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a glass paste as in claim 9.

44. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a glass paste as in claim 10.

45. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a glass paste as in claim 11.

46. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a dielectric layer precursor transferred from a transfer sheet as in claim 13.

47. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a dielectric layer precursor transferred from a transfer sheet as in claim 14.

48. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a dielectric layer precursor transferred from a transfer sheet as in claim 15.

49. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a dielectric layer precursor transferred from a transfer sheet as in claim 16.

50. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a dielectric layer precursor transferred from a transfer sheet as in claim 17.

51. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a dielectric layer precursor transferred from a transfer sheet as in claim 18.

52. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a dielectric layer precursor transferred from a transfer sheet as in claim 19.

53. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a dielectric layer precursor transferred from a transfer sheet as in claim 20.

54. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a dielectric layer precursor transferred from a transfer sheet as in claim 21.

55. A plasma display panel having a front glass substrate and a back glass substrate arranged to face each other with a plurality of display electrode pairs provided on a facing surface of the front glass substrate and a dielectric layer provided so as to cover the display electrode pairs, wherein
the dielectric layer is formed by baking a dielectric layer precursor transferred from a transfer sheet as in claim 22.
